(19) United States
(12) Patent Application Publication
(10) Pub. No.: US 2011/0159246 A1
(43) Pub. Date: Jun. 30, 2011

(54) DECORATED DEVICE AND EASY-CLEANING FILM

(75) Inventor: Kuo-Liang Ying, Taoyuan County (TW)

(73) Assignee: SiPix Chemical Inc., Taoyuan County (TW)

(21) Appl. No.: 12/712,215

(22) Filed: Feb. 25, 2010

(30) Foreign Application Priority Data
Dec. 30, 2009 (TW) 98145800

(51) Int. Cl. B32B 1/00; B32B 27/38; B32B 27/40; B32B 27/00; B32B 3/10; B32B 27/32; B32B 27/30; B32B 27/36

(52) U.S. Cl. 428/174; 428/413; 428/423.1; 428/421; 428/201; 428/412; 428/523; 428/704; 428/480; 428/522; 428/195.1; 428/500

(57) ABSTRACT

A decorated device and an easy-cleaning film are provided. The decorated device includes a body, an easy-cleaning layer, and an adhesion layer. The body has a outer surface. The easy-cleaning layer is exposed and conformally disposed on the outer surface. A material of the easy-cleaning layer includes a polymer containing fluorine. The adhesion layer is disposed between the outer surface and the easy-cleaning layer.

### CROSS-REFERENCE TO RELATED APPLICATION

This application claims the priority benefit of Taiwan application serial no. 98145800, filed Dec. 30, 2009. The entirety of the above-mentioned patent application is hereby incorporated by reference herein and made a part of specification.

### BACKGROUND OF THE INVENTION

1. Field of the Invention

The invention is related to a decorated device and a film used in the decorated device, and more particular, to an easy-cleaning decorated device and a film used for the same.

2. Description of Related Art

Conventionally, the illustrations or decorations formed on the surface of the plastic housing are mainly fabricated by spraying process or printing process to present certain visual effect. Nevertheless, the spraying process is unfavorable in mass production for the disadvantages of time consumption and process complexity. In addition, the conventional spraying process may cause the splashing of sprays containing lead or other heavy metals so that the spraying material is wasted and the problem of pollution is caused. Furthermore, during the spraying process, the mass of the coating material is not easily controlled so that the thickness is usually uneven. Particularly, when the spraying process is performed on the curve portion of the housing, the improper accumulation of the coating material is worse.

To solve the abovementioned problem, an in-mold roller (IMR) technique is provided. The process of the IMR technique includes placing a film has predetermined decorations into the mold of the injection machine, injecting a melted resin at a side of the film in the mold so that the melted resin and the film are combined to form a decorated housing, and thereafter ejecting the decorated housing from the mold. Accordingly, the in-mold roller process is completed.

However, it is not easy to clean the surface of the decorated housing if the surface stains with the dirt or the oily ink of the marker so as to smear the appearance of the housing. Therefore, a film or a decorated device having the property of easy-cleaning is required.

### SUMMARY OF THE INVENTION

The invention directs to a decorated device which has an easy-cleaning surface and is not smeared easily.

The invention directed to an easy-cleaning film apt to prevent from the stain of ink.

The invention provides a decorated device including a body, an easy-cleaning layer, and an adhesion layer. The body has a outer surface. The easy-cleaning layer is exposed and conformally disposed on the outer surface. A material of the easy-cleaning layer includes a polymer containing fluorine. The adhesion layer is disposed between the outer surface and the easy-cleaning layer.

In an embodiment of the invention, the polymer containing fluorine has a molar percentage of fluorine to a sum of fluorine plus hydrogen is substantially from 10% to 60%.

In an embodiment of the invention, the polymer containing fluorine is selected from a group consisting of olefinic fluoride, epoxy resin fluoride, aliphatic polyurethane fluoride, and a combination thereof.

In an embodiment of the present invention, the polymer containing fluorine includes polyacrylic fluoride copolymer.

In an embodiment of the invention, the decorated device further includes a pattern layer disposed between the easy-cleaning layer and the adhesion layer.

In an embodiment of the invention, a material of the body is selected from a group consisting of a thermal plastic material, a thermal curing material, a prepreg, and a combination thereof. In one embodiment, the thermal plastic material is selected from a group consisting of polycarbonate (PC), polypropylene, acryl, methylmethacrylate-styrene (MMA-st, MS) copolymer, acrylonitrile-butadiene-styrene (ABS), polystyrene (PS), polyethyleneterephthalate (PET), polyoxymethylene (POM), and a combination thereof. In addition, the thermal curing material is selected from a group consisting of polyurethane (PU), epoxy resin, unsaturated resin, vinyl, and a combination thereof.

In an embodiment of the invention, the body is formed by an injection molding process, a thermoforming process, a compression molding process, a blow molding process, a thermal printing process, an injection molding process, a compression process, and a combination thereof.

In an embodiment of the invention, a pencil hardness of the easy-cleaning layer is substantially from H to 1F.

In an embodiment of the invention, the outer surface of the body is a non-plane surface.

The invention also provides an easy-cleaning film including a substrate, a releasing layer, and an easy cleaning layer. The releasing layer is disposed on the substrate. The easy-cleaning layer is disposed on the releasing layer away from the substrate and a material of the easy-cleaning layer is mainly consisting of a polymer containing fluorine.

In an embodiment of the invention, the polymer containing fluorine has a molar percentage of fluorine to a sum of fluorine plus hydrogen is substantially from 10% to 60%.

In an embodiment of the invention, the polymer containing fluorine is selected from a group consisting of olefinic fluoride, epoxy resin fluoride, aliphatic polyurethane fluoride, and a combination thereof.

In an embodiment of the present invention, the polymer containing fluorine includes polyacrylic fluoride copolymer.

In an embodiment of the invention, the easy-cleaning film further includes a pattern layer disposed on the easy-cleaning layer away from the releasing layer.

In an embodiment of the invention, the easy-cleaning film further includes an adhesion layer disposed on the easy-cleaning layer away from the releasing layer.

In view of the above, the polymer containing fluorine is used to fabricate the easy-cleaning layer. Therefore, the easy-cleaning layer is uneasy to stain with ink. When the easy-cleaning layer is applied in the decorated device, the appearance of the decorated device is not easily smeared by staining with the ink.

In order to make the aforementioned and other features and advantages of the invention more comprehensible, embodiments accompanying figures are described in detail below.

Herein, the same or similar reference numbers used in the drawings and the descriptions are referred as the same or similar elements. For clearly describing the concept of the invention, the shapes and the thickness of the elements in the embodiments accompanying with the drawings may not definitely comply with the real circumstance. In addition, the following descriptions are directed to the elements or the combinations thereof, but the elements are not particularly restricted in the contents or the descriptions. Any form or shape known by one skilled in the art is applicable in the invention. Moreover, the description that a material layer disposed on a substrate or disposed on another material layer means that the material layer is directly located on the substrate or the another material layer, and may also mean that some interlayer is interrupted between the material layer and the substrate or between the material layer and the another material layer.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A through FIG. 1D illustrate the manufacturing process of a decorated device according to the invention.

FIG. 2A and FIG. 2B respectively illustrate an easy-cleaning film and a decorated device according to another embodiment of the invention.

### DESCRIPTION OF EMBODIMENTS

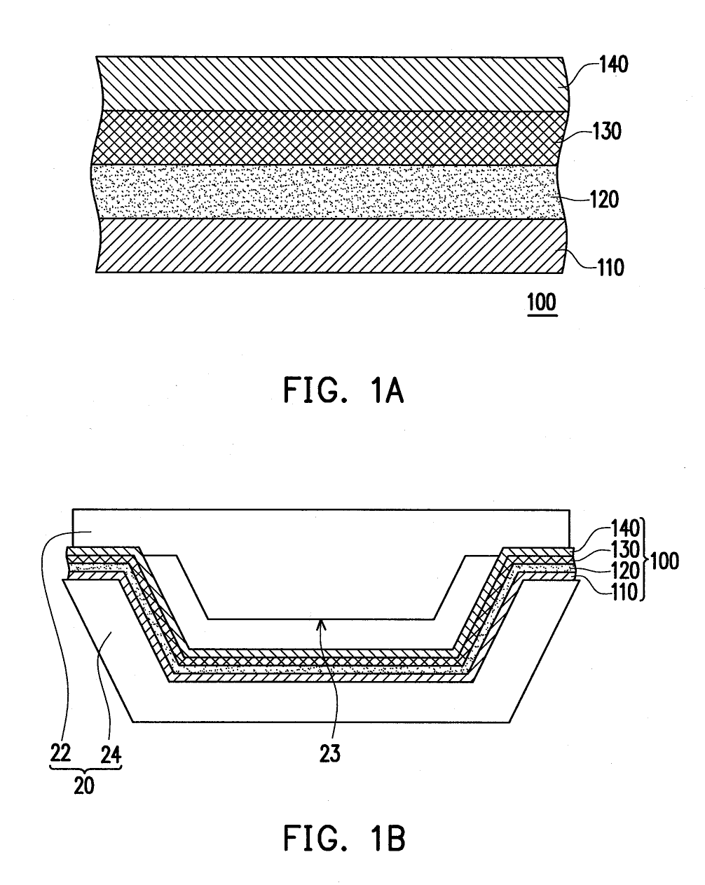

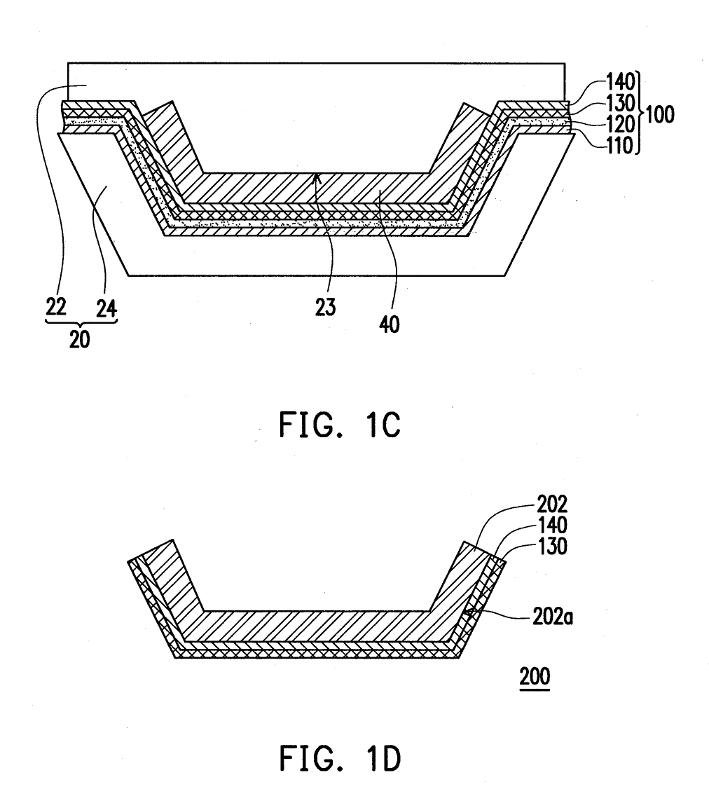

FIG. 1A through FIG. 1D illustrate the manufacturing process of a decorated device according to the invention. Referring to FIG. 1A, an easy-cleaning film 100 including a substrate 110, a releasing layer 120, an easy-cleaning layer 130, and an adhesion layer 140 is provided. The releasing layer 120, the easy-cleaning layer 130, and the adhesion layer 140 are sequentially formed on the substrate 110. Namely, the releasing layer 120 is disposed on the substrate 110, the easy-cleaning layer 130 is disposed on a side of the releasing layer 120 away from the substrate 110, and the adhesion layer 140 is disposed on a side of the easy-cleaning layer 130 away from the releasing layer 120. In the present embodiment, the adhesion layer 140 is configured for facilitating the subsequent process so that the easy-cleaning film 100 in other embodiments may not has the disposition of the adhesion layer 140.

Specifically, the formation of the easy-cleaning layer 130 includes preparing a coating material by using a polymer containing fluorine, applying the coating material on the substrate 110, and then solidifying the coating material to form the easy-cleaning layer 130. It is to say that a material of the easy-cleaning layer 130 mainly includes a polymer containing fluorine. Based on the high bonding energy of the material containing fluorine, the polymer containing fluorine can provide highly shielding effect and stereo-hindrance effect. Therefore, the surface energy of the polymer is reduced and the contacting angle of water dropping on the polymer is increased. That is to say, the polymer containing fluorine has enhanced hydrophobic effect so that water drop is rapidly slipped out the easy-cleaning layer 130. In addition, compared with the material not containing fluorine, a user may feel little resistance and much smooth when touching the easy-cleaning layer 130. The polymer containing fluorine has specific interface property to render the easy-cleaning layer 130 be uneasily staining with the dirt or ink for having the characteristic of easy-cleaning. Such material can be selected from a group consisting of olefinic fluoride, epoxy resin fluoride, aliphatic polyurethane fluoride, and a combination thereof. In an embodiment, the polymer containing fluorine includes polyacrylic fluoride copolymer. In the present embodiment, a molar percentage of fluorine to a sum of fluorine plus hydrogen in the easy-cleaning layer 130 is substantially from 10% to 60%.

In addition, a material of the substrate 110 can be polyethylene terephthalate (PET), polyethylene naphthalate (PEN), polyethylene glycol-co-cyclohexane-1,4 dimethanol terephthalate (PETG), thermalplastic polyurethane (TPU), polyurethane (PU), polypropylene (PP), polycarbonate (PC), amorphous polyethylene terephthalate (A-PET), polyvinyl chloride (PVC), Polystyrene (PS), triacetyl cellulose (TAC), polymethylmethacrylate (PMMA), methylmethacrylate-styrene (MMA-st, MS) copolymer, cyclo olefin copolymer (COC) and a combination thereof, but the invention is not restricted herein. It is noted that the substrate 110 is flexible for facilitating the subsequent process.

The releasing layer 120 is configured for temporally adhering the substrate 110 and the easy-cleaning layer 130. Accordingly, the releasing layer 120 is usually a thin film with low surface tension which can be made of a wax, a paraffin, or silicone, or an impermeable thin film with high smoothness which can be made of an irradiation curable multi-functional acrylic, silicone acrylate, epoxy, vinyl, allyl vinyl compound, unsaturated polyester or a mixture thereof. A material of the releasing layer 120 can be selected from a polycondensate, a copolymer, a blend, or a mixture consisting of epoxy, polyurethane, polyimide, polyamide, hexa methoxymethyl melamine-formaldehyde, urea-formaldehyde, phenol-formaldehyde, and a combination thereof.

The adhesion layer 140 can be made of polyacrylate, polymethacrylate, polystyrene, polycarbonate, polyurethane, polyester, polyamide, epoxy resin, ethylene vinyl acetate (EVA), thermoplastic elastomer, the like, a copolymer thereof, a blend thereof, or a mixture thereof.

Next, referring to FIG. 1B, the easy-cleaning film 100 is placed in a mold 20. The mold 20 includes, for example, a first portion 22 and a second portion 24, and a mold cavity 23 is defined by the assembly of the first portion 22 and the second portion 24. The shape of the mold cavity 23 is determined by the requirement of the products and the design concept so that the mold cavity 23 illustrated in FIG. 1B is taken as an example but not used to limit the invention. Owing to the flexibility of the substrate 110, the easy-cleaning film 100 placed in the mold cavity 23 is conformed to the inner edge of the second portion 24. In addition, the substrate 110 is directly contacted with the second portion 24 in the step and the adhesion layer 140 is exposed in the mold cavity 23.

Thereafter, referring to FIG. 1C, a polymer material 40 is injected or filled into the mold cavity 23 so that the polymer material 40 is primarily shaped along with the shape of the mold cavity 23. In the present step, an injection molding process, a thermoforming process, a compression molding process, a blow molding process, a thermal printing process, an injection molding process, a compression process, or a combination thereof can be performed. Through performing the process, the polymer material 40 is shaped according to the size and the shape of the mold cavity 23 and the easy-cleaning layer 130 is tightly adhered on the specific shaped polymer material 40 through the adhesion layer 130. In other embodiments, a hot stamping process or a laminating process can be used to tightly adhere the easy-cleaning film 100 onto the specific shaped body through the adhesion layer 140.

The polymer material 40 can be selected from a group consisting of a thermal plastic material, a thermal curing material, a prepreg, and a combination thereof. In one embodiment, the thermal plastic material is selected from a group consisting of polycarbonate (PC), polypropylene, acryl, methylmethacrylate-styrene (MMA-st, MS) copolymer, acrylonitrile-butadiene-styrene (ABS), polystyrene (PS), polyethyleneterephthalate (PET), polyoxymethylene (POM), and a combination thereof. In addition, the thermal curing material is selected from a group consisting of polyurethane (PU), epoxy resin, unsaturated resin, vinyl, and a combination thereof.

Then, referring to FIG. 1C and FIG. 1D simultaneously, an ejection process is performed to remove the mold 20. In the present embodiment, the adhesion of the releasing layer 120 to the easy-cleaning layer 130 is relative poor. Therefore, the releasing layer 120 and the substrate 110 are easily separated from the easy-cleaning layer 130 during or after the ejection process to form the decorated device 200 illustrated in FIG. 1D. The decorated device 200 includes a body 202, the easy-cleaning layer 130, and the adhesion layer 140. The material of body 202 can be the material of the above mentioned polymer material 40. In addition, the body 202 has an outer surface 202a which is exemplified as a non-plane surface. According to the above process, the easy-cleaning layer 130 is conformed to the outer surface 202a through the adhesion of the adhesion layer 140 and is exposed.

In the present embodiment, a material of the easy-cleaning layer 130 includes the polymer containing fluorine so as to have specific interface property. If the easy-cleaning layer 130 stains with certain oily ink or dirt, the oily ink or the dirt can be wiped out or cleaned. Accordingly, the appearance of the decorated device 200 is not easily smeared. In addition, no matter the outer surface 202a is a plane surface or a non-plane surface can the easy-cleaning layer 130 be conformed to the outer surface 202a. Hence, the outer surface 202a of the decorated device 200 can be made in any shape design and still have the easy-cleaning property. Furthermore, the pencil hardness of the easy-cleaning layer 130 is substantially from F to 1H so as to provide the anti-scraping property.

For clearly describing the manufacturing method and the property of the easy-cleaning layer 130, several examples and reference examples having different components are provided in the following.

### Example 1

In the example 1, the coating material for fabricating the easy-cleaning layer 130 is prepared by performing the following steps. Polyacrylic fluoride copolymer, polyurethane acrylate, and polyacrylate with weight ratio of 7:2:1 are added into a solvent to obtain the coating material having a solid component percentage of 30% and a viscosity of 33%. Polyacrylic fluoride copolymer, polyurethane acrylate, and polyacrylate can respectively be the products of number 5524B, 6160-70, and 5547 produced by ETERNAL CHEMICAL CO., and the solvent can be butanone, isopropanol, or n-propanol. Next, the coating material prepared by the aforesaid step is coated on the releasing layer 120 shown in FIG. 1A. Thereafter, a UV curing process or a thermal curing process is applied on the coating material to form the easy-cleaning layer 130.

### Example 2

The components used in the example 1 is again used in the example 2, but the weight ratio of polyacrylic fluoride copolymer to polyurethane acrylate to polyacrylate is 5:2:3 in the example 2.

### Example 3

The components used in the example 1 is again used in the example 3, but the weight ratio of polyacrylic fluoride copolymer to polyurethane acrylate to polyacrylate is 5:4:1 in the example 3.

### Example 4

The manufacturing method of easy-cleaning layer 130 used in the example 4 is similar to that used in the example 1, but the polyurethane acrylate used in example 1 is replaced by aliphatic polyurethane acrylate in the example 4. In the current example, aliphatic polyurethane acrylate can be the product of number 6195-100 produced by ETERNAL CHEMICAL CO.

### Example 5

The manufacturing method of the easy-cleaning layer 130 used in example 5 is similar to that used in the example 1, but the polyurethane acrylate used in example 1 is replaced by bis-phenol A type epoxy acrylate in the example 5. In the current example, bis-phenol A type epoxy acrylate can be the product of number 622A-80 produced by ETERNAL CHEMICAL CO.

### Reference Example 1

The reference example 1 is provided by preparing a testing layer through the manufacturing method depicted in the example 1, but polyacrylic fluoride copolymer mentioned in the example 1 is not used in the reference example 1. That is to say, no fluoride is added in the test layer of the reference example 1.

### Reference Example 2

The reference example 2 is provided by preparing a testing layer through the manufacturing method depicted in the example 1, but the weight ratio of polyacrylic fluoride copolymer to polyurethane acrylate to polyacrylate is 1:X:9−X in the reference example 2, wherein X is smaller than 9 and larger than 0. That is to say, the content of fluoride is rare in the test layer of the reference example 2.

The following tests are performed in the easy-cleaning layers 130 and the testing layers prepared according to the abovementioned examples and reference examples. A tester uses the same marker which is, for example, the marker produced by LION CO. for drawing a label on the easy-cleaning layers 130 and the testing layers. Then, the tester uses the tissue to wipe the easy-cleaning layers 130 and the testing layers and simultaneously observes with his or her eyes whether the label is eliminated. When the label is eliminated, a note of wiping-able is recorded and then the steps of the drawing, the wiping, and the recording are duplicated until the label is incapable of wiping out. The record made by the tester is shown in the table 1. In addition, the table 1 further shows the number of times which the easy-cleaning layers 130 and the testing layers are not damaged under a loading test of 175 grams by using the R.C.A. abrasion tester.

TABLE 1

| | | | | | | [Ref- | [Ref- |
|---|---|---|---|---|---|---|---|
| | | | | [Ex- | [Ex- | erence | erence |
| | [Ex- | [Ex- | [Ex- | am- | am- | Exam- | Exam- |
| | ample | ample | ample | ple | ple | ple | ple |
| | 1] | 2] | 3] | 4] | 5] | 1] | 2] |
| Times of | ≧10 | ≧4 | ≧2 | ≧8 | ≧8 | 0 | 0 |
| wiping- | | | | | | | |
| able | | | | | | | |
| Times of | 150 | 150 | 150 | 200 | 200 | 150 | 150 |
| anti- | | | | | | | |
| scrapping | | | | | | | |

According to the table 1, the easy-cleaning layers 130 having polymer containing fluorine can be cleaned for many times after staining with the oily ink while the fluorine-rare or fluorine-free testing layers can hardly be cleaned after staining with the oily ink. Therefore, the containing of fluorine is conducive to provide the easy-cleaning property. In addition, according to the testing result of the R.C.A. abrasion tester, the easy-cleaning layer 130 has not only the easy-cleaning property but also the anti-scraping property so that the decorated device 200 can maintain the original and distinct appearance after several times of scraping.

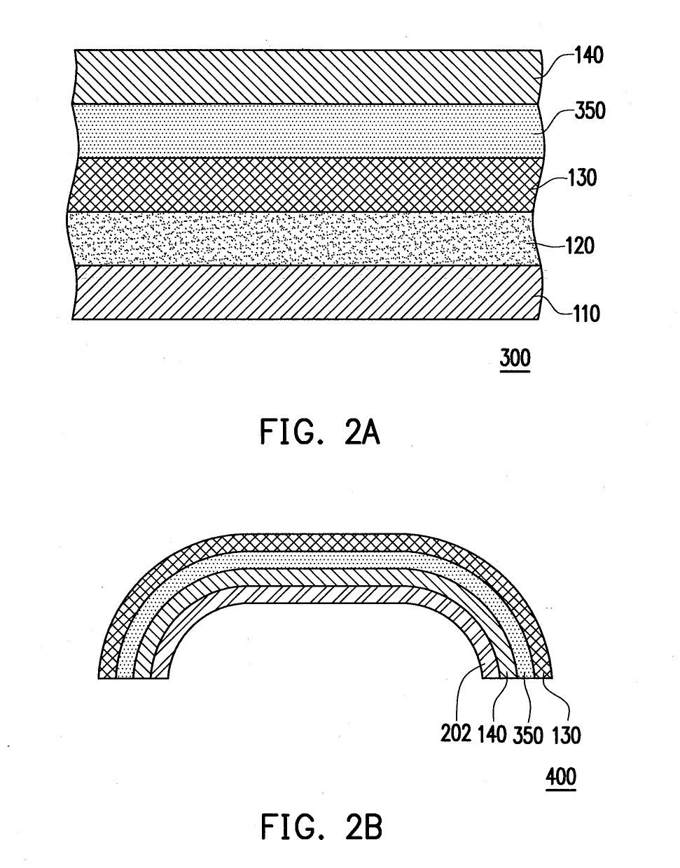

FIG. 2A and FIG. 2B respectively illustrate an easy-cleaning film and a decorated device according to another embodiment of the invention. Referring to FIG. 2A, an easy cleaning film 300 includes the abovementioned substrate 110, the abovementioned releasing layer 120, the abovementioned easy-cleaning layer 130, and the abovementioned adhesion layer 140 and further includes a pattern layer 350. The pattern layer 350 is disposed on a side of the easy-cleaning layer 130 away from the releasing layer 120. Specifically, the pattern layer 350 is disposed between the easy-cleaning layer 130 and the adhesion layer 140.

In the present embodiment, the easy-cleaning film 300 can be used to fabricate the decorated device 400 shown in FIG. 2B by the aforesaid manufacturing process as shown in FIGS. 1B through 1D. Therefore, in addition to the body 202, the easy-cleaning layer 130, and the adhesion layer 140, the decorated device 400 further has the pattern layer 350. The disposition of the pattern layer 350 provides the decoration patterns or colors so as to enhance the attraction of the decorated device 400.

Similarly, the easy-cleaning layer 130 provides the characteristics of easy-cleaning and anti-scraping.

In summary, the decorated device is fabricated by the decoration mold process using the film made of polymer containing fluorine in the invention. Therefore, the surface of the decorated device has the easy-cleaning property. When the surface of the decorated device is stained with oil or dirt, merely a wiping step is used to clean surface. Accordingly, the decorated device is not easily smeared so as to maintain the original appearance thereof. Furthermore, the easy-cleaning layer has desirable anti-scraping property to facilitate the completeness of the appearance.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A decorated device, comprising:
a body, having an outer surface;
an easy-cleaning layer conformally disposed on the outer surface and being exposed, and a material of the easy-cleaning layer comprises a polymer containing fluorine; and
an adhesion layer disposed between the outer surface and the easy-cleaning layer.

2. The decorated device as claimed in claim 1, wherein the polymer containing fluorine has a molar percentage of fluorine to a sum of fluorine plus hydrogen is substantially from 10% to 60%.

3. The decorated device as claimed in claim 1, wherein the polymer containing fluorine is selected from a group consisting of olefinic fluoride, epoxy resin fluoride, aliphatic polyurethane fluoride, and a combination thereof.

4. The decorated device as claimed in claim 1, wherein the polymer containing fluorine comprises polyacrylic fluoride copolymer.

5. The decorated device as claimed in claim 1, further comprising a pattern layer disposed between the easy-cleaning layer and the adhesion layer.

6. The decorated device as claimed in claim 1, wherein a material of the body is selected from a group consisting of a thermal plastic material, a thermal curing material, a prepreg, and a combination thereof.

7. The decorated device as claimed in claim 6, wherein the thermal plastic material is selected from a group consisting of polycarbonate (PC), polypropylene, acryl, methylmethacrylate-styrene (MMA-st, MS) copolymer, acrylonitrile-butadiene-styrene (ABS), polystyrene (PS), polyethyleneterephthalate (PET), polyoxymethylene (POM), and a combination thereof.

8. The decorated device as claimed in claim 6, wherein the thermal curing material is selected from a group consisting of polyurethane (PU), epoxy resin, unsaturated resin, vinyl, and a combination thereof.

9. The decorated device as claimed in claim 1, wherein the body is formed by molding, stamping, lamination, or a combination thereof.

10. The decorated device as claimed in claim 9, wherein the molding is injection molding process, thermoforming process, compression molding process, blow molding process and a combination thereof.

11. The decorated device as claimed in claim 1, wherein a pencil hardness of the easy-cleaning layer is from H to 1F.

12. The decorated device as claimed in claim 1, wherein the outer surface of the body is a non-plane surface.

13. An easy-cleaning film, comprising:
a substrate;
a releasing layer disposed on the substrate; and
an easy-cleaning layer disposed on the releasing layer away from the substrate and a material of the easy-cleaning layer being mainly consisting of a polymer containing fluorine.

14. The easy-cleaning film as claimed in claim 13, wherein the polymer containing fluorine has a molar percentage of fluorine to a sum of fluorine plus hydrogen is substantially from 10% to 60%.

15. The easy-cleaning film as claimed in claim 13, wherein the polymer containing fluorine is selected from a group consisting of olefinic fluoride, epoxy resin fluoride, aliphatic polyurethane fluoride, and a combination thereof.

16. The easy-cleaning film as claimed in claim 13, wherein the polymer containing fluorine comprises polyacrylic fluoride copolymer.

17. The easy-cleaning film as claimed in claim 13, further comprising a pattern layer disposed on the easy-cleaning layer away from the releasing layer.

18. The easy-cleaning film as claimed in claim 13, further comprising an adhesion layer disposed on the easy-cleaning layer away from the releasing layer.
